(19) United States
(12) Patent Application Publication
(10) Pub. No.: US 2015/0053607 A1
(43) Pub. Date: Feb. 26, 2015

(54) Graphene Derivative Composite Membrane And Method For Fabricating The Same

(71) Applicant: CHUNG-YUAN CHRISTIAN UNIVERSITY, Tao-Yuan (TW)

(72) Inventors: Wei-Jen Liu, Taoyuan County (TW); Wei-Song Hung, Taoyuan County (TW); Juin-Yih Lai, Taoyuan County (TW); Kueir-Rarn Lee, Taoyuan County (TW)

(73) Assignee: CHUNG-YUAN CHRISTIAN UNIVERSITY, Tao-Yuan (TW)

(21) Appl. No.: 14/060,930

(22) Filed: Oct. 23, 2013

(30) Foreign Application Priority Data
Aug. 26, 2013 (TW) 102130473

(51) Int. Cl. B01D 71/68; B01D 71/16; B01D 67/00; B01D 71/64; B01D 61/36; B01D 71/42; B01D 71/34

(52) U.S. Cl. CPC B01D 71/68; B01D 71/42; B01D 71/16; B01D 71/34; B01D 71/64; B01D 61/362; B01D 67/0088
USPC 210/500.3; 210/500.21; 210/500.43; 210/500.42; 210/500.41; 210/500.39; 427/243

(57) ABSTRACT

The invention provides a graphene derivative composite membrane and method for fabricating the same. The graphene derivative composite membrane comprises a support membrane made of porous polymer and a plurality of graphene derivative layers disposed on the support membrane wherein the distance between adjacent graphene derivative layers is about 0.3˜1.5 nm and the total thickness of the plurality of graphene derivative layers is more than 100 nm.

### BACKGROUND OF THE INVENTION

1. Field of the Invention

The present invention is generally related to a composite membrane and method for fabricating the same, and more particularly to a graphene derivative composite membrane and method for fabricating the same.

2. Description of the Prior Art

A commonly used method for separation of alcohol and water, for example, is distillation, membrane separation and so forth. However, accompanying with industrial development, a mixture of alcohol and water is extensive used in a cleaning step of production processes, especially in semiconductor processes, solar cell processes, etc. so as to produce a large amount of waste water containing both alcohol and water. Till recently, there is no effective recycling and purifying method to process the waste water. Under the consideration of environmental protection, energy conservation, and cost reduction, an effective recycling and purifying method is urgently needed.

The membrane separation method to separate alcohol and water, compared to the distillation method, is a preferred method under the consideration of environmental protection, energy conservation, and cost reduction. However, the efficiency of the separation membrane affects the practicability in separating alcohol and water. The membrane for separating alcohol and water, for example, is a polyacrylonitrile composite membrane, referring to H. Ohya et. al, J. of membrane Science, Vol. 68, issue 1-2, pp. 141-148 (1992) or a chitosan composite membrane, referring to M. Ghazali et. al, J. of membrane Science, Vol. 124, issue 1, pp. 53-62 (1997). However, the membrane separation method is to perform pervaporation at a temperature about 60˜70° C. and thus has problems of energy consuming, low separation efficiency, bad separation efficiency, bad separation outcome and poor practicability.

On the other hand, an earlier report disclosed a graphene oxide membrane (R. R. Nair et. al, Science, Vol. 335, pp. 442-444 (2012)), as a standalone membrane, is impermeable to helium but allow unimpeded permeation of water. However, the above mentioned membrane in a solution is apt to be damaged or torn and thus cannot be dipped in a liquid for solution separation, especially for the above mentioned water treatment. The membrane can be used only in gas separation.

Therefore, a novel separation membrane having good separation outcome and good separation efficiency, applicable to separate alcohol and water from waste water, such as processing waste water, is urgently needed.

### SUMMARY OF THE INVENTION

In light of the above background, in order to fulfill the requirements of industries, one object of the present invention is to provide a graphene derivative composite membrane and a method for fabricating the same, using a plurality of graphene derivative layers to effectively separate alcohol and water from their mixture, especially to separate isopropyl alcohol.

One object of the present invention is to provide a graphene derivative composite membrane, when the composite membrane is impregnated in pure water, having a pore diameter larger than the pore diameter when the graphene derivative composite membrane is impregnated in alcohol and besides having a distance between adjacent graphene derivative layers being varied with concentration change of water or alcohol in the mixture when the graphene derivative composite membrane is impregnated in a mixture of water and alcohol so as to become an intelligent separation membrane.

In order to achieve the above purposes, the present invention discloses a graphene derivative composite membrane, comprising: a supporting membrane, made of a porous polymer; and a plurality of graphene derivative layers, disposed on the supporting membrane wherein a distance between adjacent graphene derivative layers is 0.3˜1.5 nm and a total thickness of the graphene derivative layers is more than 100 nm.

In one embodiment, the graphene derivative layers are formed by using a dispersion solution of graphene derivatives to deposit the graphene derivatives via a high pressure method onto the supporting membrane.

In one embodiment, the supporting membrane is a porous membrane made of a polymer selected from the group consisting of the following: polyacrylonitrile, cellulose acetate, polyvinylidene fluoride, polysulfone, and polyimide. The supporting membrane has an average pore diameter of 0.05˜0.1 μm.

In one embodiment, the graphene derivative has an average particle diameter of 1˜200 μm.

In one embodiment, the graphene derivative composite membrane impregnated in pure water has a pore diameter larger than the pore diameter when the graphene derivative composite membrane is impregnated in alcohol. Furthermore, when the graphene derivative composite membrane impregnated in a mixture of water and alcohol, the graphene derivative composite membrane has a distance between adjacent graphene derivative layers (layer-to-layer distance of the graphene derivative layers) being varied with concentration change of water or alcohol in the mixture.

In one embodiment, the supporting membrane has an average pore diameter of 50˜300 nm on its surface and has an average pore diameter of 1˜5 μm on its cross section.

In one embodiment, a total thickness of the graphene derivative layers is between 100 nm and 1000 nm.

In one embodiment, the high pressure method is performed by a gas pressure of 5˜10 Kg/cm².

Furthermore, according to another embodiment of the present invention, a method for fabricating a graphene derivative composite membrane is disclosed. The method comprises the following steps: providing a supporting membrane to dispose the supporting membrane on a bottom of a container; adding graphene derivatives in a solvent and stirring until uniform so as to obtain a uniform graphene derivative dispersion solution; having the graphene derivative dispersion solution overlaying on the supporting membrane; and applying a high pressure from the side of the graphene derivative dispersion solution to force a liquid to pass through the supporting membrane to deposit a plurality of graphene derivative layers on the supporting membrane so as to obtain a graphene derivative composite membrane.

In one embodiment, the method of applying a high pressure is performed by a gas pressure of 5˜10 Kg/cm².

In one embodiment, the supporting membrane is made of a porous polymer and the supporting membrane has an average pore diameter of 50˜300 nm on its surface and has an average pore diameter of 1˜5 μm on its cross section.

In one embodiment, the supporting membrane is a porous membrane made of a polymer selected from the group consisting of the following: polyacrylonitrile, cellulose acetate, polyvinylidene fluoride, polysulfone, and polyimide.

In one embodiment, a total thickness of the graphene derivative layers is between 100 nm and 1000 nm.

In one embodiment, a distance between adjacent graphene derivative layers is 0.3˜1.5 nm.

In one embodiment, the graphene derivative composite membrane impregnated in pure water has a pore diameter larger than the pore diameter when the graphene derivative composite membrane is impregnated in alcohol.

Moreover, according to one other embodiment of the present invention, an isopropyl alcohol separation membrane is disclosed. The isopropyl alcohol separation membrane is made of a graphene derivative composite membrane for separating isopropyl alcohol from a mixture containing isopropyl alcohol by pervaporation wherein the graphene derivative composite membrane comprises: a supporting membrane, made of a porous polymer; and a plurality of graphene derivative layers, disposed on the supporting membrane wherein a distance between adjacent graphene derivative layers is 0.3˜1.5 nm and a total thickness of the graphene derivative layers is more than 100 nm.

In one embodiment, the graphene derivative layers are formed by using a dispersion solution of graphene derivatives to deposit the graphene derivatives via a high pressure method onto the supporting membrane.

In one embodiment, the graphene derivative composite membrane impregnated in pure water has a pore diameter larger than the pore diameter when the graphene derivative composite membrane is impregnated in alcohol and, when the graphene derivative composite membrane impregnated in a mixture of water and alcohol has a distance between adjacent graphene derivative layers (layer-to-layer distance of the graphene derivative layers) being varied with concentration change of water or alcohol in the mixture.

In one embodiment, the supporting membrane is a porous membrane made of a polymer selected from the group consisting of the following: polyacrylonitrile, cellulose acetate, polyvinylidene fluoride, polysulfone, and polyimide; the supporting membrane has an average pore diameter of 1˜5 μm; the graphene derivative has an average particle diameter of 1˜200 μm; a total thickness of the graphene derivative layers is between 0.3 nm and 5000 nm.

Moreover, according to one other embodiment of the present invention, a method for fabricating an isopropyl alcohol separation membrane is disclosed. The isopropyl alcohol separation membrane is made of a graphene derivative composite membrane for separating isopropyl alcohol from a mixture containing isopropyl alcohol by pervaporation.

In conclusion, according to the graphene derivative composite membrane and the method for fabricating the same of the present invention, pervaporation can be performed at a low temperature to separate isopropyl alcohol from a mixture containing isopropyl alcohol and the graphene derivative composite membrane can be applied in the application of waste water separation of alcohol and water, such as semiconductor or solar cell processing waste water. Furthermore, when the composite membrane is impregnated in pure water, the composite membrane has a pore diameter larger than the pore diameter when the graphene derivative composite membrane is impregnated in alcohol and besides has a distance between adjacent graphene derivative layers being varied with concentration change of water or alcohol in the mixture when the graphene derivative composite membrane is impregnated in a mixture of water and alcohol. Thus, the graphene derivative composite membrane can be used as an intelligent separation membrane.

### BRIEF DESCRIPTION OF THE DRAWINGS

FIG. 1 shows a cross sectional schematic diagram illustrating a structure of a graphene derivative composite membrane according to one embodiment of the present invention;

FIG. 2 shows a cross sectional schematic diagram illustrating a plurality of graphene derivative layers according to one embodiment of the present invention viewed by a transmission electron microscope;

FIG. 3 shows a schematic diagram illustrating a separation device utilizing an isopropyl alcohol separation membrane according to one embodiment of the present invention;

FIG. 4 shows a schematic diagram illustrating a separation mechanism of an isopropyl alcohol separation membrane according to one embodiment of the present invention; and

FIG. 5 shows a schematic diagram illustrating the relationship between the thickness of the graphene derivative layer and the deposition density of the graphene derivative according to one embodiment of the present invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. The drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The common structures and elements that are known to everyone are not described in details to avoid unnecessary limits of the invention. Some preferred embodiments of the present invention will now be described in greater detail in the following.

According to one embodiment of the present invention, a graphene derivative composite membrane is provided. The graphene derivative composite membrane comprises: a supporting membrane, made of a porous polymer; and a plurality of graphene derivative layers, disposed on the supporting membrane wherein a distance between adjacent graphene derivative layers is 0.3˜1.5 nm and a total thickness of the graphene derivative layers is more than 100 nm.

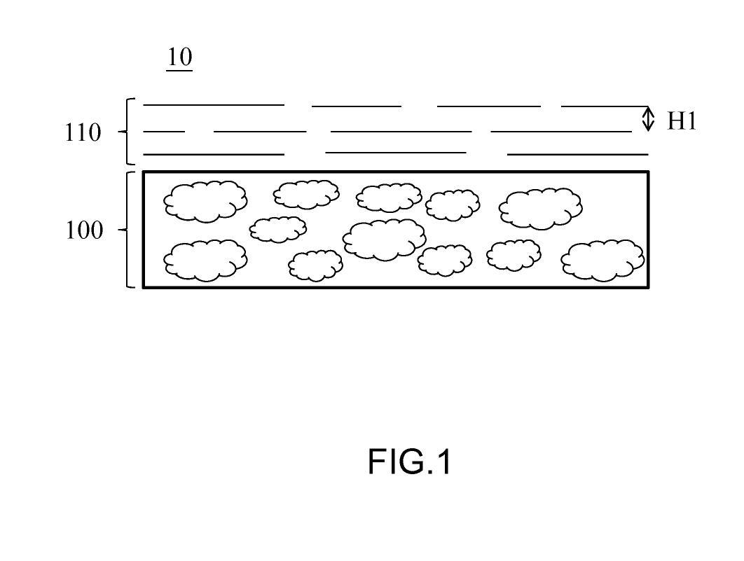

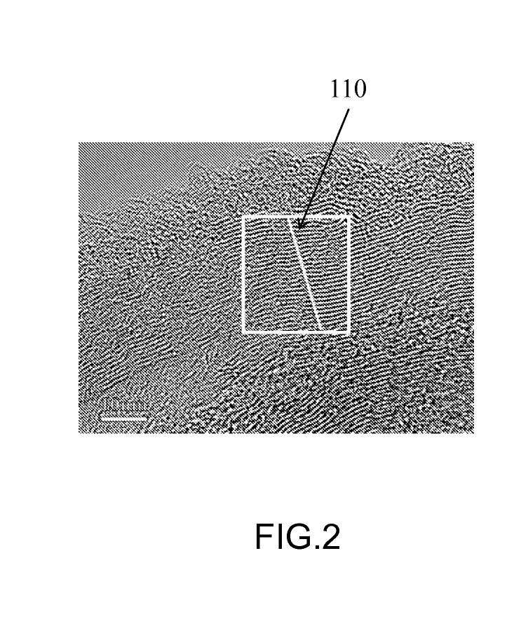

FIG. 1 shows a cross sectional schematic diagram illustrating a structure of a graphene derivative composite membrane according to one embodiment of the present invention. FIG. 2 shows a cross sectional schematic diagram illustrating a plurality of graphene derivative layers according to one embodiment of the present invention viewed by a transmission electron microscope. The graphene derivative composite membrane 10 comprises a supporting membrane 100 and a plurality of graphene derivative layers 110. The layer-to-layer distance of the graphene derivative layers (distance between adjacent layers, in a direction perpendicular to the surface of the composite membrane or in a thickness direction of the composite membrane) H1 is preferably 0.3˜1.5 nm. When the graphene derivative composite membrane is used in isopropyl alcohol separation, the layer-to-layer distance H1 is preferably about equal to the hydrated diameter of isopropyl alcohol.

The graphene derivative is preferably graphene oxide since graphene oxide includes hydrophilic moieties, such as O—H, C═O, C—O, etc. so as to have graphene simultaneously possess hydrophilic ends and hydrophobic ends that is preferably as a separation membrane.

The above mentioned supporting membrane is for example formed by a porous membrane. For example, the supporting membrane of the present invention can be formed from polyacrylonitrile, cellulose acetate, polyvinylidene fluoride, polysulfone, or polyimide. The supporting membrane has an average pore diameter of 1˜5 μm. Specifically, the supporting membrane can be made from polyacrylonitrile, cellulose acetate, polyvinylidene fluoride, polysulfone, or polyimide through wet-phase inversion.

The graphene derivative layers can be formed by using a dispersion solution of graphene derivatives to deposit the graphene derivatives via a high pressure method onto the supporting membrane. The high pressure method is performed by a gas pressure of 5˜10 Kg/cm². When the pressure is less than 5 Kg/cm², the stacked structure (multiple layers) of the present invention cannot be achieved. Furthermore, the graphene derivative has an average particle diameter of 1˜200 μm and the structure shown in FIG. 1 can be formed by utilizing flake-like graphene. The dispersion solution of graphene derivatives can be obtained by having graphene derivatives dispersed in a solvent to obtain a mixture solution and then using stirring the mixture solution via supersonic oscillation. The preparation method for graphene derivatives, for example, to mix graphene powders (3˜150 μm) and sodium nitrate, add sulfuric acid into the mixture in an ice bath, stir until uniform, add potassium permanganate, heat until boiling, and finally perform refinement so as to obtain graphene oxide.

The graphene derivative composite membrane impregnated in pure water has a pore diameter larger than the pore diameter when the graphene derivative composite membrane is impregnated in alcohol. Furthermore, when the graphene derivative composite membrane impregnated in a mixture of water and alcohol has a pore diameter being varied with concentration change of water or alcohol in the mixture

The total thickness of the graphene derivative layers is between 0.3 nm and 5000 nm. In the above range, the composite membrane can have good separation characteristic of isopropyl alcohol.

Furthermore, according to another embodiment of the present invention, a method for fabricating a graphene derivative composite membrane is provided. The method comprises the following steps:

Step S10: providing a supporting membrane to dispose the supporting membrane on a bottom of a container;

Step S20: adding graphene derivatives in a solvent and stirring until uniform so as to obtain a uniform graphene derivative dispersion solution;

Step S30: having the graphene derivative dispersion solution overlaying on the supporting membrane; and

Step S40: applying a high pressure from a side of the graphene derivative dispersion solution to force a liquid to pass through the supporting membrane to deposit a plurality of graphene derivative layers on the supporting membrane so as to obtain a graphene derivative composite membrane.

The following examples are represented in order to further illustrate the graphene derivative composite membrane and the method for fabricating the same of the present invention.

### Example 1

### (1) Preparation of a Graphene Derivative Dispersion Solution

3 g of graphene powders and 1.5 g of sodium nitrate were weighted and placed in a 250 mL 3-neck flask and the flask was moved and placed in an ice bath. 72 mL of conc. sulfuric acid was slowly added and the mixture was stirred until uniform. Then 9 g of potassium permanganate was added into the mixture and the mixture was maintained at a temperature lower than 20° C. After all potassium permanganate was added, the flask was moved to be placed outside the ice bath and the temperature of the mixture was raised to 35° C. The mixture was stood under this situation for 30 minutes and then the mixture became black. 138 mL of distilled water was slowly added and the mixture became extremely boiling. The temperature was raised to about 105° C. At the time, the viscous black solution gradually became yellow-brown and was not boiling anymore. At this temperature for 15 mins, the yellow-brown solution was transferred to a 1 L beaker and 420 mL of distilled water was added for further dilution. Finally, 12 mL of hydrogen peroxide was added. The unreacted potassium permanganate and produced manganese dioxide were reduced to become dissolvable manganese sulfate and at the time the mixture became light-yellow.

The mixture went through suction filtration and rinsed by a large amount of distilled water to remove excess acid. The filtered cake was taken to be re-dispersed in distilled water and added with hydrochloric acid solution (HCl: water=1:10). Suction filtration was performed again in order to wash out the residual metal salts. This step was repeated twice. Then, the filter cake was taken and placed in a dialysis bag to wash until becoming neutral. Finally, yellow-brown residue was dried to obtain yellow-brown solids, that is, graphene oxide (GO). The obtained GO was weighted and added into deionized water to obtain a GO mixture. The GO mixture was under supersonic oscillation to obtain the graphene derivative dispersion solution.

### (2) Fabricating a Supporting Membrane

Polyacrylonitrile (PAN) was dissolved in N-methylpyrrolidone (NMP) solvent to prepare a 15 wt % of casting solution. The casting solution was completely stirred until uniform by a magnetic stirrer at an appropriate temperature and then stood still for a day to remove bubbles due to stirring. The casting solution was scraped and placed on non-woven cloth to form a non-woven cloth with the uniform casting solution by wet-phase inversion. Then, the cloth was dipped in a cohesion bath (water). Since the solvent and cohesion agent (10-25 wt % of N-methyl-2-pyrrolidone (NMP)) exchanged quickly, it was quickly solidified to form a membrane. The cohesion agent in the cohesion bath was repeatedly replaced to remove the residual solvent in the membrane. The substrate membrane was taken out to be placed in air for drying and then the PAN substrate was to be modified. At first, the substrate membrane was dipped in a 2M NaOH solution and placed in an oven to process for 2 hrs at 50° C. to hydrolyze —CN moieties of PAN into —COOH or —CONH₂. The modified PAN substrate was taken and then dipped in water to rinse for one day. Finally, the substrate was taken out and placed at room temperature for drying. Then, the substrate membrane was kept in water for further use. The average pore diameter of the surface of the supporting membrane PAN was 50˜300 nm and the cross sectional average pore diameter is 1˜5 μm.

### (3) Fabricating a Composite Membrane

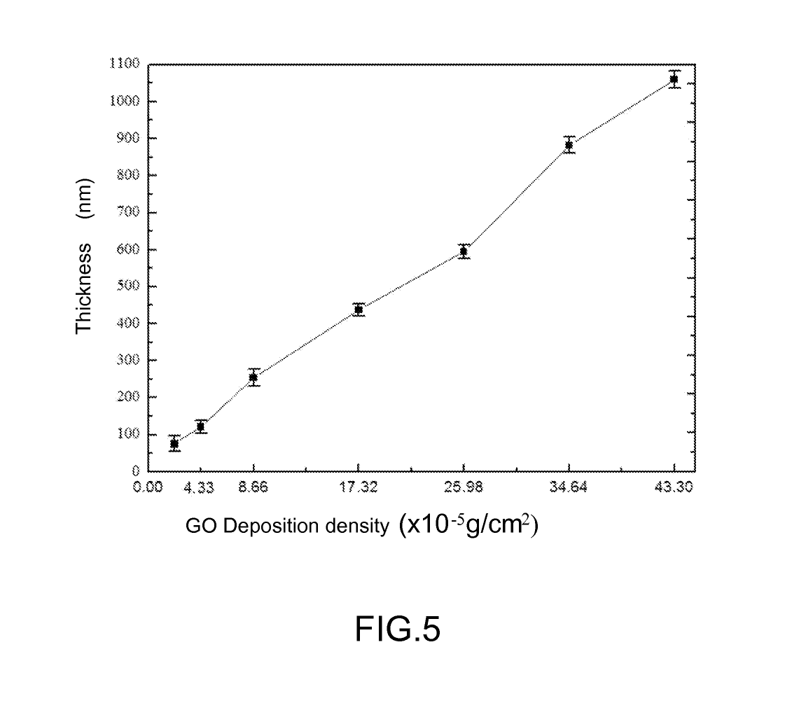

A proper amount of GO was taken and added into deionized water. The mixture was under supersonic oscillation to obtain a GO dispersion solution. The prepared GO dispersion solution with proper amount was taken and the pressurized filtration method was used to deposit the GO dispersion solution onto the PAN substrate membrane to obtain a GO/PAN membrane. The GO/PAN membrane after washed by deionized water went through pressurized filtration and then dried at room temperature. Then, the prepared membrane was placed in an oven set at 50° C. for 1 hr to obtain a graphene derivative composite membrane. FIG. 5 shows a schematic diagram illustrating the relationship between the thickness of the graphene derivative layer and the deposition density of the graphene derivative according to one embodiment of the present invention.

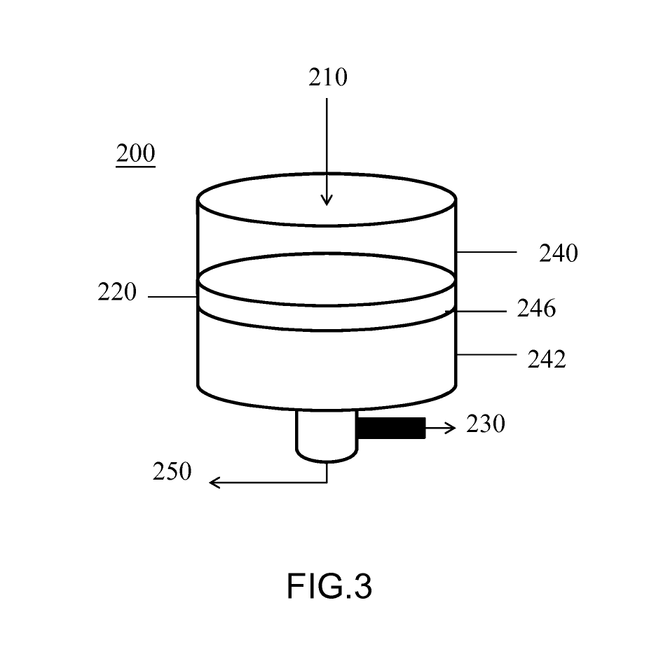

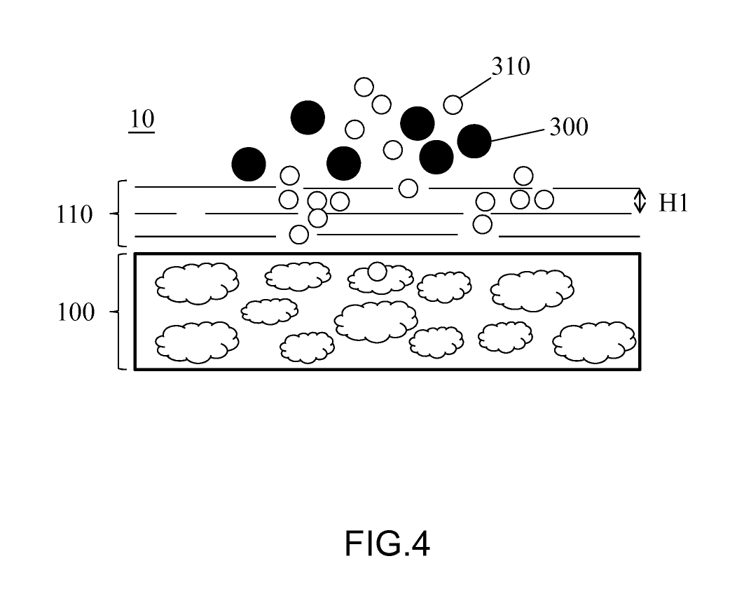

Moreover, according to another embodiment of the present invention, an isopropyl alcohol separation membrane is provided. The isopropyl alcohol separation membrane is formed by the above mentioned graphene derivative composite membrane. By pervaporation at a temperature lower than 40° C., isopropyl alcohol can be separated from a mixture containing isopropyl alcohol. FIG. 3 shows a schematic diagram illustrating a separation device utilizing an isopropyl alcohol separation membrane according to one embodiment of the present invention. FIG. 4 shows a schematic diagram illustrating a separation mechanism of an isopropyl alcohol separation membrane according to one embodiment of the present invention. The separation device 200 comprises an inlet chamber 240, a supporting station 246, an outlet chamber 242, a suction pump 230 connected to the outlet chamber 242, a separated fluid outlet opening 250 and an isopropyl alcohol separation membrane 220 disposed on the supporting station 246 (stainless steel mesh). The mixture 210 is to be poured into the inlet chamber 240 and then be sucked by the suction pump 230. The mixture 210 passes through the isopropyl alcohol separation membrane to obtain a separated fluid to flow out from the separated fluid outlet opening 250. Different isopropyl alcohol separation membranes 1˜7 are used and a mixture solution of isopropyl alcohol and water (70 wt % of isopropyl alcohol) is used as the mixture 210. At 30° C., the separation device 200 is used to obtain different deposition quantities and separation membrane permeation so as to have different separation efficiency. The separation efficiency is determined by the concentration of water in the separated fluid. That is, the higher the concentration of water in the separated fluid, the better the separation efficiency. The result is shown in Table 1.

TABLE 1
separation efficiency for different deposition quantities
of graphene derivative

| | | | separation efficiency |
|---|---|---|---|
| | deposition | | (water concentration |
| Exp. | quantity | Permeation | in the separated |
| No. | (×10⁻⁵ g/cm²) | (g/m²h) | fluid) (%) |
| 1 | 2.17 | 3960 | 86.4 |
| 2 | 4.33 | 2027 | 98.1 |
| 3 | 8.66 | 2047 | 99.8 |
| 4 | 17.32 | 1944 | 99.5 |
| 5 | 25.98 | 1880 | 99.6 |
| 6 | 34.64 | 1748 | 99.7 |
| 7 | 43.30 | 1867 | 99.5 |

Besides, different mixtures 210 are used and the permeation and separation efficiency (water concentration in the separated fluid) are measured. The result is shown in Table 2 where the membranes used in Experiment No. 8˜11 are the same as that in Experiment No. 3.

TABLE 2
permeation and separation efficiency for different
mixtures

| | | | separation efficiency |
|---|---|---|---|
| | | | (water concentration |
| Exp. | | Permeation | in the separated |
| No. | Mixture | (g/m²h) | fluid) (%) |
| 8 | 90 wt % | 981 | 73.8 |
| | methanol | | |
| 9 | 90 wt % | 1604 | 92.3 |
| | ethanol | | |
| 10 | 70 wt % | 2047 | 99.8 |
| | isopropyl | | |
| | alcohol | | |
| 11 | 50 wt % | 1144 | 88.7 |
| | acetic acid | | |

Besides, different supporting membranes are used and the permeation and separation efficiency (water concentration in the separated fluid) are measured. The result is shown in Table 2 where the deposition amount of graphene derivative of the membranes used in Experiment No. 12˜46 is the same as that in Experiment No. 3.

TABLE 3
permeation and separation efficiency for different
supporting membranes

| | | | separation efficiency |
|---|---|---|---|
| | | | (water concentration |
| Exp. | Supporting | Permeation | in the separated |
| No. | membrane | (g/m²h) | fluid) (%) |
| 12 | polyacrylonitrile | 2047 | 99.8 |
| 13 | cellulose acetate | 2376 | 99.2 |
| 14 | polyvinylidene | 1733 | 83.6 |
| | fluoride | | |
| 15 | polysulfone | 1967 | 99.5 |
| 16 | polyimide | 764 | 99.9 |

In conclusion, according to the graphene derivative composite membrane and the method for fabricating the same of the present invention, pervaporation can be performed at a low temperature to separate isopropyl alcohol from a mixture containing isopropyl alcohol and the graphene derivative composite membrane can be applied in the application of waste water separation between alcohol and water, such as semiconductor or solar cell processing waste water. Furthermore, when the composite membrane is impregnated in pure water, the composite membrane has a pore diameter larger than the pore diameter when the graphene derivative composite membrane is impregnated in alcohol and besides has (a pore diameter) a distance between adjacent graphene derivative layers being varied with concentration change of water or alcohol in the mixture when the graphene derivative composite membrane is impregnated in a mixture of water and alcohol. Thus, the graphene derivative composite membrane can be used as an intelligent separation membrane.

In one embodiment, a total thickness of the graphene derivative layers is between 100 nm and 1000 nm. The graphene derivative layers are disposed on the supporting membrane and a distance between adjacent graphene derivative layers is 0.3˜1.5 nm and a total thickness of the graphene derivative layers is more than 100 nm.

In one embodiment, the supporting membrane is a porous membrane made of a polymer selected from the group consisting of the following: polyacrylonitrile, cellulose acetate, polyvinylidene fluoride, polysulfone, and polyimide; the supporting membrane has an average pore diameter of 1˜5 μm; the graphene derivative has an average particle diameter of 1˜200 μm; a total thickness of the graphene derivative layers is between 0.3 nm and 5000 nm.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A graphene derivative composite membrane, comprising:
a supporting membrane, made of a porous polymer; and
a plurality of graphene derivative layers, disposed on the supporting membrane wherein a distance between adjacent graphene derivative layers is 0.3˜1.5 nm and a total thickness of the graphene derivative layers is more than 0.3 nm.

2. The graphene derivative composite membrane according to claim 1, wherein the graphene derivative layers are formed by using a dispersion solution of graphene derivatives to deposit the graphene derivatives via a high pressure method onto the supporting membrane.

3. The graphene derivative composite membrane according to claim 1, wherein the supporting membrane is a porous membrane made of a polymer selected from the group consisting of the following: polyacrylonitrile, cellulose acetate, polyvinylidene fluoride, polysulfone, and polyimide.

4. The graphene derivative composite membrane according to claim 2, wherein the graphene derivative has an average particle diameter of 1˜200 μm.

5. The graphene derivative composite membrane according to claim 1, wherein the graphene derivative composite membrane impregnated in pure water has a pore diameter larger than the pore diameter when the graphene derivative composite membrane is impregnated in alcohol.

6. The graphene derivative composite membrane according to claim 1, wherein, when the graphene derivative composite membrane impregnated in a mixture of water and alcohol, the graphene derivative composite membrane has a distance between adjacent graphene derivative layers being varied with concentration change of water or alcohol in the mixture.

7. The graphene derivative composite membrane according to claim 1, wherein the supporting membrane has an average pore diameter of 50˜300 nm on its surface and has an average pore diameter of 1˜5 μm on its cross section.

8. The graphene derivative composite membrane according to claim 1, wherein a total thickness of the graphene derivative layers is between 100 nm and 1000 nm.

9. The graphene derivative composite membrane according to claim 2, wherein the high pressure method is performed by a gas pressure of 5˜10 Kg/cm².

10. A method for fabricating a graphene derivative composite membrane, comprising:
providing a supporting membrane to dispose the supporting membrane on a bottom of a container;
adding graphene derivatives in a solvent and stirring until uniform so as to obtain a uniform graphene derivative dispersion solution;
having the graphene derivative dispersion solution overlaying on the supporting membrane; and
applying a high pressure from the side of the graphene derivative dispersion solution to force a liquid to pass through the supporting membrane to deposit a plurality of graphene derivative layers on the supporting membrane so as to obtain a graphene derivative composite membrane.

11. The method according to claim 10, wherein the method of applying a high pressure is performed by a gas pressure of 5˜10 Kg/cm².

12. The method according to claim 10, wherein the supporting membrane is made of a porous polymer and the supporting membrane has an average pore diameter of 50˜300 nm on its surface and has an average pore diameter of 1˜5 μm on its cross section.

13. The method according to claim 10, wherein the supporting membrane is a porous membrane made of a polymer selected from the group consisting of the following: polyacrylonitrile, cellulose acetate, polyvinylidene fluoride, polysulfone, and polyimide.

14. The method according to claim 10, wherein a total thickness of the graphene derivative layers is between 100 nm and 1000 nm.

15. The method according to claim 10, wherein a distance between adjacent graphene derivative layers is 0.3˜1.5 nm.

16. The method according to claim 10, wherein the graphene derivative composite membrane impregnated in pure water has a pore diameter larger than the pore diameter when the graphene derivative composite membrane is impregnated in alcohol.

17. An isopropyl alcohol separation membrane, being made of a graphene derivative composite membrane, for separating isopropyl alcohol from a mixture containing isopropyl alcohol by pervaporation, wherein the graphene derivative composite membrane comprises:
a supporting membrane, made of a porous polymer; and
a plurality of graphene derivative layers, disposed on the supporting membrane wherein a distance between adjacent graphene derivative layers is 0.3˜1.5 nm and a total thickness of the graphene derivative layers is more than 0.3 nm.

18. The isopropyl alcohol separation membrane according to claim 17, wherein the plurality of graphene derivative layers are formed by using a dispersion solution of graphene derivatives to deposit the graphene derivatives via a high pressure method onto the supporting membrane.

19. The isopropyl alcohol separation membrane according to claim 17, wherein the graphene derivative composite membrane impregnated in pure water has a pore diameter larger than the pore diameter when the graphene derivative composite membrane is impregnated in alcohol and, when the graphene derivative composite membrane impregnated in a mixture of water and alcohol, the graphene derivative composite membrane has a distance between adjacent graphene derivative layers being varied with concentration change of water or alcohol in the mixture.

20. The isopropyl alcohol separation membrane according to claim 17, wherein the supporting membrane is a porous membrane made of a polymer selected from the group consisting of the following:
polyacrylonitrile, cellulose acetate, polyvinylidene fluoride, polysulfone, and polyimide; the supporting membrane has an average pore diameter of 1˜5 μm; the graphene derivative has an average particle diameter of 1˜200 μm; a total thickness of the graphene derivative layers is between 0.3 nm and 5000 nm.
